(19) United States
(12) Patent Application Publication
(10) Pub. No.: US 2016/0108666 A1
(43) Pub. Date: Apr. 21, 2016

(54) Systems and Methods for Aligning Roll-Up Door Curtains

(71) Applicants: Derek Lewan, Dubuque, IA (US); Nicholas J. Casey, Cascade, IA (US); Perry W. Knutson, Lancaster, WI (US); Ryan Pfaff, Dubuque, IA (US); Steven Campbell, Peosta, IA (US); Thomas Jansen, Dubuque, IA (US); William W. Hoerner, Dubuque, IA (US)

(72) Inventors: Derek Lewan, Dubuque, IA (US); Nicholas J. Casey, Cascade, IA (US); Perry W. Knutson, Lancaster, WI (US); Ryan Pfaff, Dubuque, IA (US); Steven Campbell, Peosta, IA (US); Thomas Jansen, Dubuque, IA (US); William W. Hoerner, Dubuque, IA (US)

(21) Appl. No.: 14/515,156

(22) Filed: Oct. 15, 2014

(51) Int. Cl. E06B 9/58

(52) U.S. Cl. CPC E06B 9/58

(57) ABSTRACT

Example systems and methods for aligning roll-up door curtains are disclosed. An example door includes a roller that is rotatable about an axis. The door further includes a curtain having a wrapped section wrapped around the roller and an unwrapped section extending tangentially away from the wrapped section. The unwrapped section adjoins the wrapped section at a first point proximate a first end of the roller and at a second point proximate a second end of the roller. The axis is closer to the second point than to the first point when the curtain is at the intermediate position. In some examples, the door includes a guide member to guide the curtain on to the roller.

### FIELD OF THE DISCLOSURE

This patent generally pertains to roll-up doors and more specifically to systems and methods for aligning roll-up door curtains.

### BACKGROUND

Typical roll-up doors comprise a flexible curtain that when the door is open the curtain is wound about a roller above the doorway. To close the door, the curtain unwinds as two vertical tracks guide the curtain across the doorway. Roll-up doors are typically either powered open and closed or are powered open and allowed to fall closed by gravity.

Some roll-up doors are powered by a drive unit that can rotate the curtain's roller in either direction to open or close the door. Other roll-up doors are powered by a drive unit that drivingly engages the curtain itself while the roller takes up any curtain slack as the door opens.

### BRIEF DESCRIPTION OF THE DRAWINGS

FIG. 1 is a front view of an example door (in a closed position) constructed in accordance with the teachings disclosed herein.

FIG. 2 is a front view similar to FIG. 1 but showing the example door in an intermediate or partially open position.

FIG. 3 is a front view similar to FIG. 1 but showing the example door in an open position.

FIG. 4 is a cross-sectional view taken along line 4-4 of FIG. 1.

FIG. 5 is a cross-sectional view similar to FIG. 4 but showing another example door constructed in accordance with the teachings disclosed herein.

FIG. 6 is a front view of FIG. 5 without the addition of a corrective shim

FIG. 7 is a front view similar to FIG. 6 but with an example corrective shim added.

FIG. 8 is a right end view of an example roller and an example curtain (in a closed position) constructed in accordance with the teachings disclosed herein.

FIG. 9 is a right end view similar to FIG. 8 but showing the example curtain at an intermediate position.

FIG. 10 is a right end view similar to FIG. 8 but showing the example curtain in the open position.

FIG. 11 is a right end view similar to FIG. 8 but showing another example roller and an example curtain constructed in accordance with the teachings disclosed herein.

FIG. 12 is a right end view similar to FIG. 8 but with the addition of an example shim constructed in accordance with the teachings disclosed herein.

FIG. 13 is a right end view similar to FIG. 12 but showing the example curtain at an intermediate position.

FIG. 14 is a right end view similar to FIG. 12 but showing the example curtain in the open position.

FIG. 15 is a top schematic diagram of FIGS. 12-14.

FIG. 16 is a right end view similar to FIG. 12 but showing the example shim installed at an alternate location.

FIG. 17 is a right end view similar to FIG. 12 but showing the example shim installed at another alternate location when the curtain is at an intermediate position.

FIG. 18 is a front view similar to FIG. 1 but showing another example door constructed in accordance with the teachings disclosed herein.

FIG. 19 is a cross-sectional view taken along line 19-19 of FIG. 18.

FIG. 20 is a block diagram illustrating an example door method in accordance with the teachings disclosed herein.

FIG. 21 is a front view similar to FIG. 2 but showing another example door constructed in accordance with the teachings disclosed herein.

FIG. 22 is an enlarged front view of the upper right corner of the example door of FIG. 21.

FIG. 23 is a cross-sectional view taken along line 23-23 of FIG. 22.

FIG. 24 is a cross-sectional view taken along line 24-24 of FIG. 22.

FIG. 25 is a front view similar to FIGS. 2 and 21 but showing another example door constructed in accordance with the teachings disclosed herein.

FIG. 26 is an enlarged front view of the upper right corner of the example door of FIG. 25.

FIG. 27 is a cross-sectional view taken along line 27-27 of FIG. 26.

FIG. 28 is a cross-sectional view taken along line 28-28 of FIG. 26.

### DETAILED DESCRIPTION

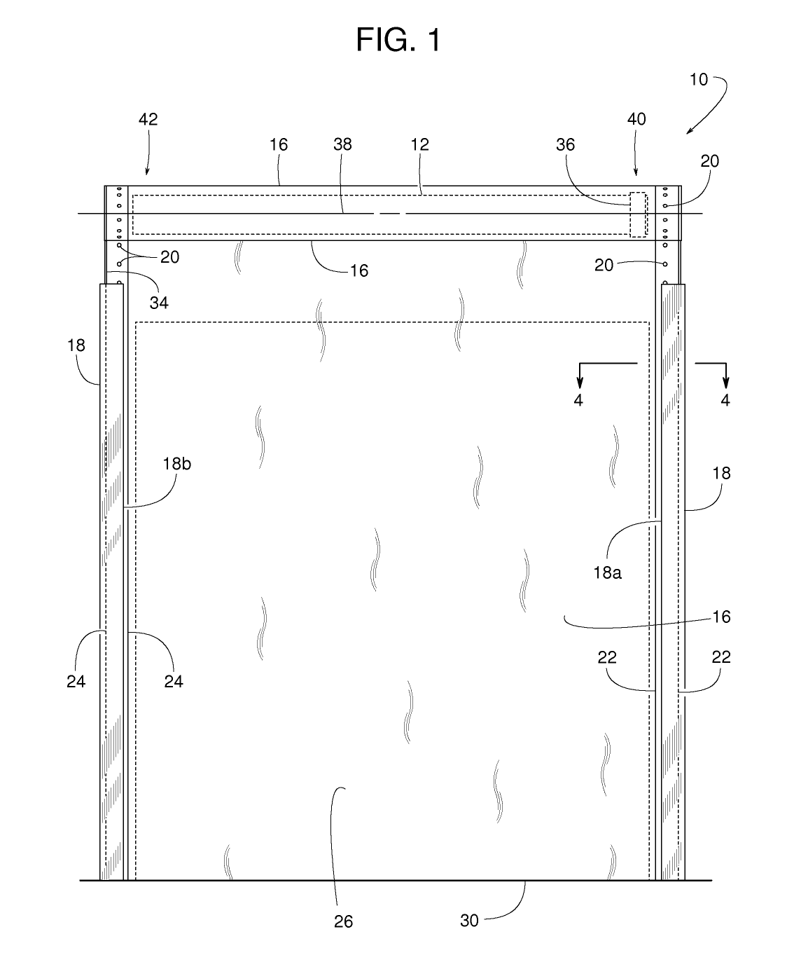

FIGS. 1-20 illustrate example systems and methods for adjusting or maintaining the curtain of a roll-up door square to the curtain's take-up roller and/or in alignment with vertical tracks guiding the curtain. Some example curtains are brought into alignment by attaching a flexible shim to one end of the curtain's take-up roller to increase the roller's effective diameter or circumference at that end. In other examples, the shim is attached to the upper end of the curtain near one or both ends of the roller, depending on the problem being corrected. In some examples where the curtain's lateral edges are much thicker than the main section of the curtain, shims can help compensate for the difference in thickness and thus help in evenly wrapping the curtain around the roller.

The example systems and methods disclosed herein apply to a wide variety of door and curtain designs.

The illustrated examples of FIGS. 1-4, for instance, show a door 10 comprising a roller 12 installed above a doorway 14; a curtain 16 attached to, wrapped around and hanging from the roller 12; and a set of tracks 18 (e.g., a first track 18a and a second track 18b) that helps guide and/or retain the curtain's lateral edges.

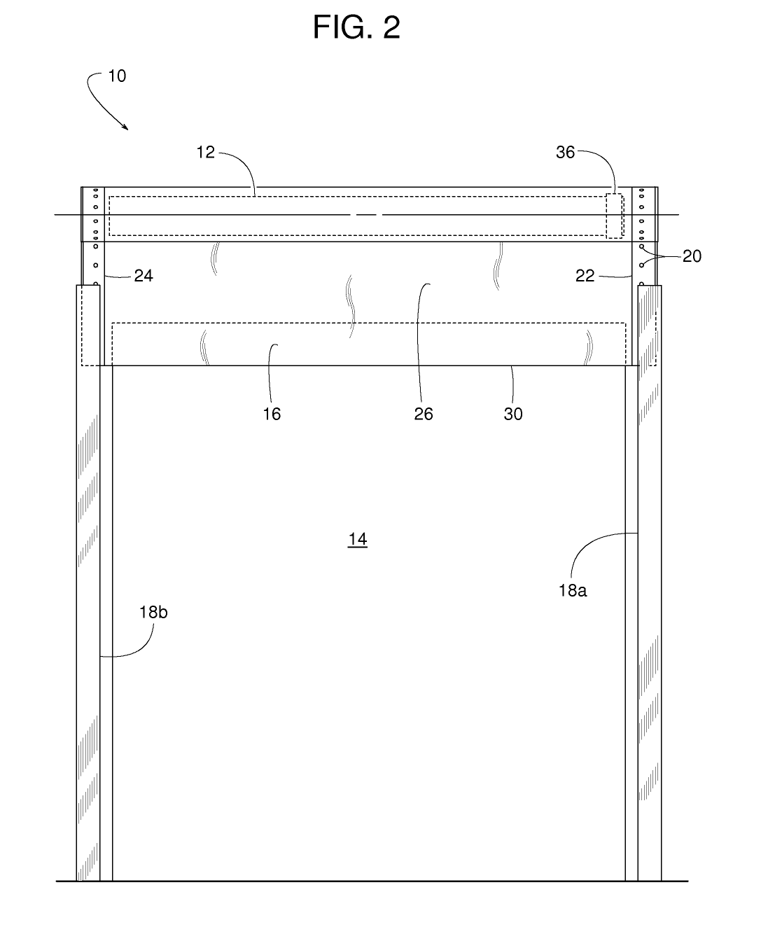

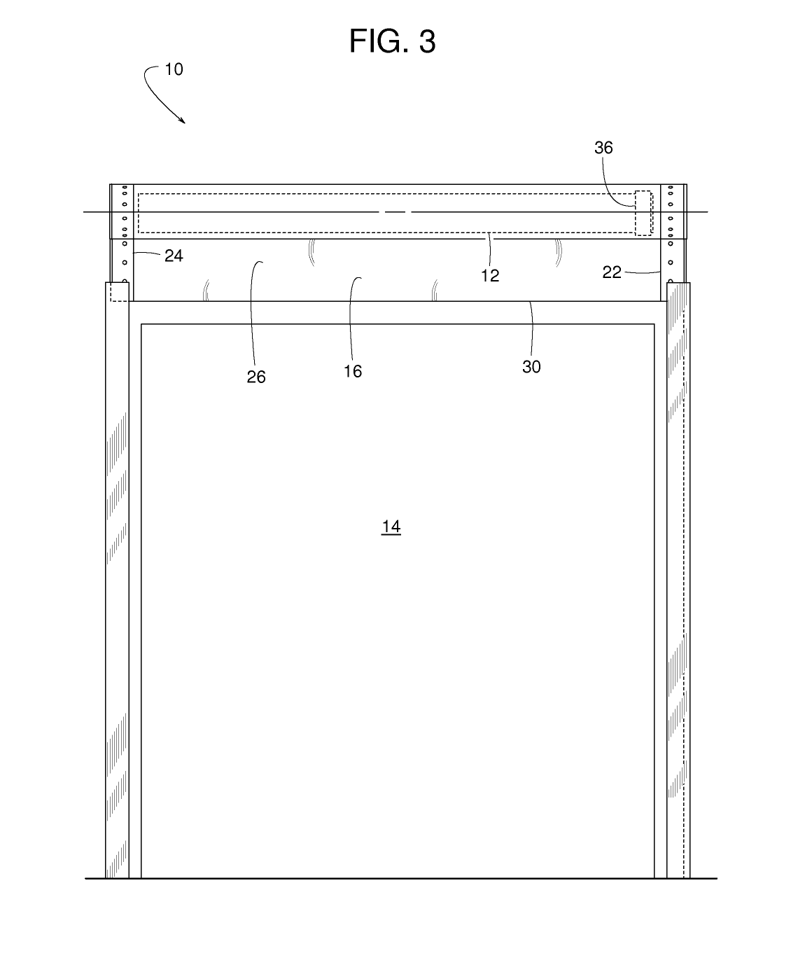

In the illustrated example, the curtain 16 is moveable selectively to a closed position (FIG. 1), an open position (FIG. 3) and a range of partially open positions, such as the intermediate position shown in FIG. 2. In some examples, the rotation of the roller 12 is powered to raise and lower the curtain 16. In other examples, a separate drive mechanism (e.g., a sprocket) engages buttons 20 or engages some other feature of the curtain 16 to open and close the door 10 while a counterweight or spring acts upon the roller 12 such that the roller 12 automatically takes up any curtain slack as the separate drive mechanism raises the curtain 16.

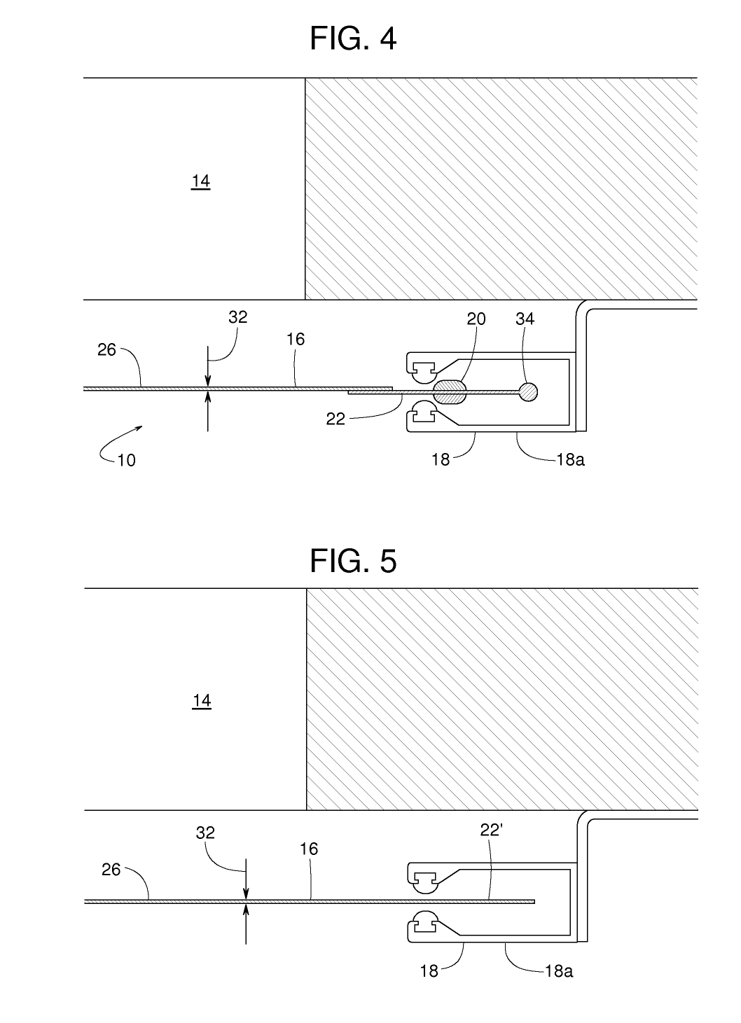

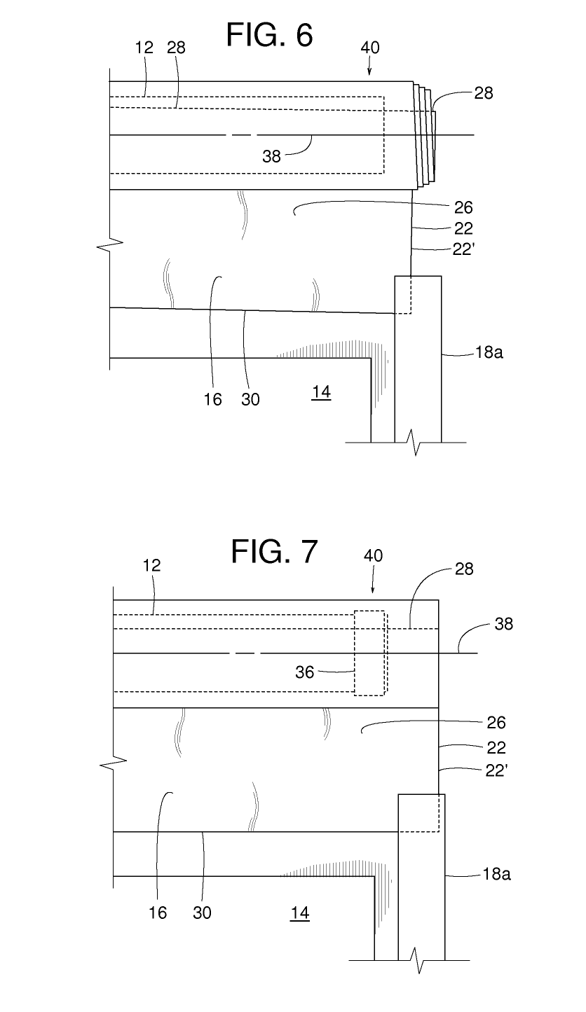

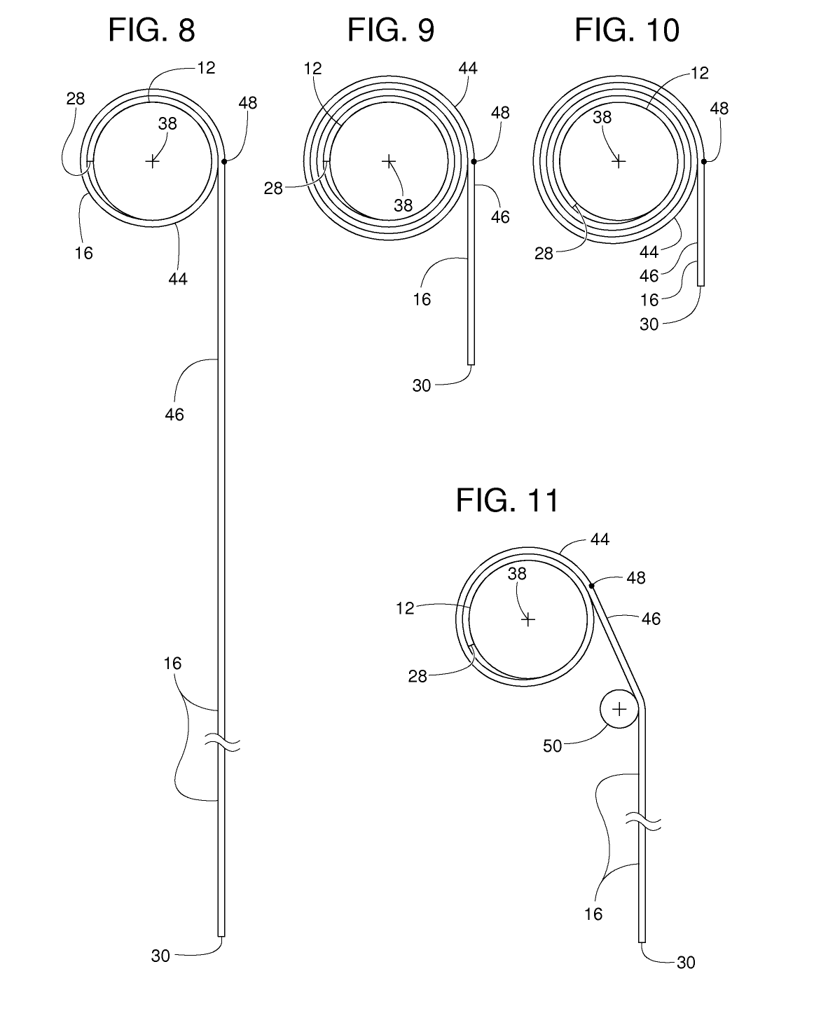

In the example illustrated in FIGS. 1-4, the curtain 16 comprises a first edge section 22 extending into the first track 18a, a second edge section 24 extending into the second track 18b, a main section 26 extending between the edge sections 22, 24, an upper end 28 (e.g., FIGS. 6 and 8) attached to the roller 12, and a lower end 30 that moves vertically across the doorway 14. Example means for attaching the curtain's upper end 28 to the roller 12 include hook-and-loop fasteners, screws, adhesive, tape, nails, and/or clamps. The main section 26 is any sheet of material that is sufficiently flexible to readily wrap around the roller 12. In some examples, the main section 26 is made of 27-ounce vinyl (nominal 27 ounces per square yard). In some examples, the main section 26 has an average material thickness 32 of about 0.026 inches (FIGS. 4, 5 and 19).

The edge sections 22, 24, in some examples, are extruded pieces of low friction UHMW (Ultra High Molecular Weight Polyethylene) that are ultrasonically bonded or otherwise attached to the main section 26. Some examples of the edge sections 22, 24 include the buttons 20 for retention within the tracks 18. In addition or alternatively, some examples of the edge sections 22, 24 include a raised portion 34 (or portion of greater thickness) extending substantially continuously along the curtain 16 (e.g., a keder edge) for lateral retention of the curtain 16, for maintaining the curtain 16 in alignment, and/or for facilitating the refeeding of the edge sections 22, 24 back into the tracks 18 following a breakaway incident. In some examples, the edge sections 22, 24 include neither the buttons 20 nor the raised portion 34. For instance, in the example shown in FIG. 5, the curtain 16 comprises an edge section 22′ that is simply an integral extension of the main section 26.

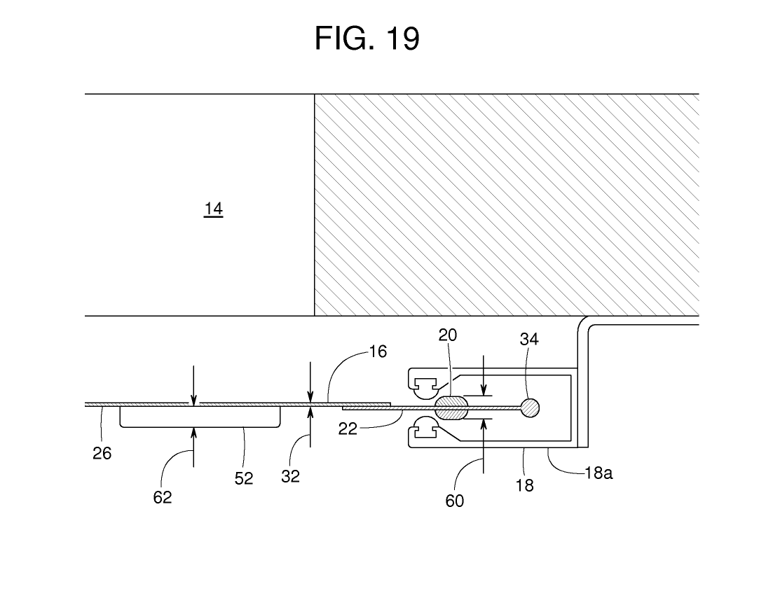

In some examples, the curtain 16 is in proper alignment when the edge sections 22, 24 are evenly squared with the corresponding track 18a, 18b to provide a desired amount of tension on each lateral edge of the curtain 16. That is, the curtain 16 is aligned when each of the edge sections 22, 24 extend into each of the corresponding tracks 18a, 18b a substantially equivalent distance that facilitates the proper guidance of the curtain 16 along the tracks 18. In other words, the curtain 16 is aligned as it rolls and unrolls about the roller 12 when the curtain is substantially centered relative to the tracks 18a, 18b. The curtain is substantially centered when the retention elements (e.g., the buttons 20, the raised portion 34, etc.) are neither rubbing nor pressed against either the inside or outside walls of the track 18 and/or associated components as shown in FIG. 19. By contrast, the curtain 16 is misaligned when one of the edge sections 22, 24 extends further into the corresponding track 18a, 18b than the other edge section 22, 24 extends into the other track 18a, 18b. In such situations, the edge section 22, 24 extending an excess distance into the track may cause the curtain 16 to unduly rub against the corresponding track 18a, 18b resulting in wear to the curtain 16 and/or the curtain binding up and preventing the door 10 from operating properly. Likewise, the edge section 22, 24 that does not sufficiently extend into the track may result in increased pressure on the retention elements (e.g., the buttons 20 and/or the raised portion 34) resulting in wear to the curtain 16, the door 10 failing to operate properly, and/or an increased likelihood that the edge section 22, 24 will become dislodged from the track 18. In other examples, the curtain 16 is misaligned when both edge sections 22, 24 insufficiently extend into the tracks 18 (e.g., as the lateral edges on both sides travel inward while the curtain 16 is rolled up). In such examples, the edge sections 22, 24 may press against the track 18 as described above. Further, such inward movement may cause slack within the main section 26 of the curtain such that the curtain 16 no longer winds up around the roller 12 properly. In some examples, the curtain 16 may be aligned when the curtain 16 is in the closed position (or at some different position) but become misaligned as the curtain moves to some other position due to lateral movement of the curtain 16 as it winds or unwinds about the roller 12.

In FIGS. 6-17, curtain 16 is schematically illustrated to represent different types of door curtains including those shown in FIGS. 4 and 5. FIG. 6 shows the curtain 16 at an open position in a misaligned first wrapped configuration around the roller 12, and FIG. 7 shows the same curtain 16 at an open position in a properly aligned second wrapped configuration. That is, as the curtain 16 has been wound around the roller in the misaligned first wrapped configuration of FIG. 6, the curtain's lower end 30 has become laterally offset with respect to the curtain's lower end 30 when the curtain 16 is aligned in the proper second wrapped configuration of FIG. 7 such that the edge section 22 does not extend into the track 18a the correct amount to be properly guided. A misaligned wrapped configuration can increase curtain wear, increase track wear, reduce door speed, and/or cause the curtain to jam, buckle or wrinkle.

In the misaligned first wrapped configuration of the illustrated example of FIG. 6, the roller 12 does not include a shim 36, and the curtain 16 wraps unevenly around the roller 12. The unevenness can be due to any number of reasons, examples of which include one lateral edge of the curtain 16 being thicker than the other, the roller 12 being slightly conical instead of perfectly cylindrical, surface irregularities of the curtain 16, surface irregularities of the roller 12, the roller 12 not being perfectly horizontal, the curtain's edge sections 22, 24 not being perfectly perpendicular to the roller's rotational axis 38, and/or the curtain's upper end 28 being parallel to the axis 38 but not perfectly perpendicular to the curtain's edge sections 22, 24 (e.g., during manufacturing, the curtain 16 was cut at a slight angle instead of square to the edge sections 22, 24).

To correct the problem of uneven wrapping, in some examples, the shim 36 is installed at one end of the roller 12 to compensate for unevenness in the roller 12 and/or the curtain 16 and/or other causes of misalignment. In the illustrated example, the shim 36 is installed at the roller's first end 40 to increase the effective circumference or effective diameter of that end of the roller 12. As a result, the curtain 16 wraps evenly around the roller 12 to the second wrapped configuration shown in FIG. 7.

In examples where the shim 36 is taped, fastened (e.g., screws, hook-and-loop, etc.), glued or otherwise attached to the roller 12, the attached the shim 36 becomes part of the roller 12. For instance, in examples where the shim 36 is attached to a cylindrical roller, the roller comprises both its cylindrical portion and the shim 36. Thus, an attached shim increases a roller's circumference in the area of the shim. In some examples, the roller 12 is supported by a shaft, shaft stubs, and/or bearings that rotate about the axis 38. In some examples, the curtain's wrapped lateral edge sections (e.g., the sections 22, 24) overhang the roller's ends 40, 42. The wrapped section of the curtain extending (in a direction parallel to the axis 38) beyond the roller ends 40, 42 is particularly useful in minimizing material buildup of relatively thick edge sections that might otherwise stack irregularly on the roller 12.

FIGS. 8, 9 and 10 show a right end view of the curtain 16 and the roller 12 with respect to FIG. 6, in which case the shim 36 is omitted. FIG. 8 shows the example curtain 16 in a closed position, FIG. 9 shows the example curtain 16 at an intermediate position, and FIG. 10 shows the example curtain 16 in an open position. In the illustrated example, the upper end 28 of the curtain 16 is attached to the roller 12 to create a wrapped section 44 around the roller 12 and an unwrapped section 46. The unwrapped section 46 adjoins the wrapped section 44 along a tangential axis 48 from which the unwrapped section 46 begins extending linearly away from the roller 12 and the wrapped section 44. In the open position of the illustrated example of FIG. 10, the wrapped section 44 includes a greater portion of the curtain 16 than the unwrapped section 46. In the closed position of the illustrated example of FIG. 8, the unwrapped section 46 includes a greater portion of the curtain 16 than the wrapped section 44. Consequently, the line 48 is closer to the axis 38 when the curtain 16 is in the closed position than when the curtain 16 is in the open position. In some such examples, as shown in FIG. 11, the door 10 includes the addition of an idler roller 50 that aligns the curtain 16 in the same plane as the tracks 18 regardless of the position of the line 48 relative to the axis 38 (e.g., regardless of whether the door is open or closed).

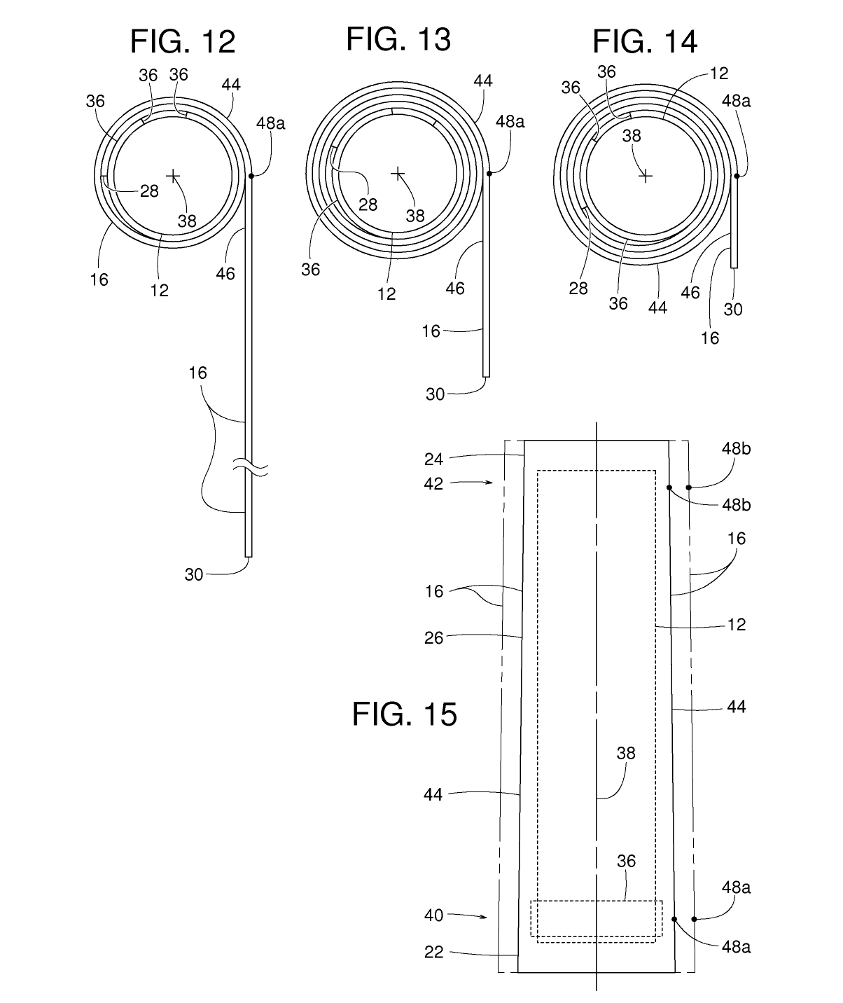

FIGS. 12, 13 and 14 show a right end view of the curtain 16 and the roller 12 with respect to FIG. 7, in which case the shim 36 is attached to the roller 12 to help align the otherwise misaligned curtain 16 to the roller 12. FIG. 12 shows the example curtain 16 in a closed position, FIG. 13 shows the example curtain 16 at an intermediate position, and FIG. 14 shows the example curtain 16 in an open position. In the illustrated example, the upper end 28 of the curtain 16 is attached to the shim 36 of the roller 12 and/or is attached to another suitable part of the roller 12. The curtain 16, in this example, also provides a wrapped section 44 around the roller 12 and an unwrapped section 46.

FIG. 15 is a schematic top view of FIGS. 12 and 14, wherein the dotted lines of FIG. 15 only pertain to FIG. 14. In the illustrated example, the unwrapped section 46 adjoins the wrapped section 44 along a tangential axis defined between a first point 48a proximate the first end 40 of the roller 12 and a second point 48b proximate the second end 42 of the roller 12. Similar to the tangential axis 48 of FIGS. 8-11, the axis defined by points 48a, 48b in FIGS. 12-15 identify where the unwrapped section 46 begins extending linearly away from the roller 12 and the wrapped section 44. However, unlike the tangential axis 48 (FIGS. 8-11) that is substantially parallel to the central axis 38 of the roller 12, the tangential axis defined between the points 48a, 48b (FIGS. 12-15) is not parallel with the central axis 38. That is, with the addition of the shim 36, which increases the effective circumference and effective diameter of the roller's first end 40, the axis 38 is closer to the second point 48b than to the first point 48a when the curtain 16 is at the open, closed and/or intermediate position. Further, similar to the tangential axis 48 of FIGS. 8-11, points 48a, 48b in FIGS. 12-15 are closer to the axis 38 when the curtain 16 is in the closed position than when the curtain 16 is in the open position.

Changing the shim's size (e.g., particularly its thickness, circumferential length around the roller 12, and/or its vertical length extending down along the curtain 16) provides a means for adjusting the difference in the effective circumference between each end 40, 42 of the roller 12. In some examples, the thickness of the shim 36 ranges between 0.25 inches and 1.0 inch. In some examples, when the shim 36 is attached to the roller, the circumferential length of the shim 36 extends only a portion of the way around the roller. In other such examples, the circumferential length of the shim 36 extends the entire circumference of the roller. In some examples, when the shim 36 is attached to the curtain, the vertical length corresponds to a similar length as a shim 36 attached to the roller. In other such examples, the vertical length of the shim 36 may be greater than the circumferential length of the roller 12 (e.g., two times the length, three times the length, etc.). In other examples, the shim 36 may extend all or substantially all of the length of the curtain 16. Adjusting the difference in the effective circumference of the ends 40, 42 by adding a shim 36 to one end provides a way of aligning the curtain 16 with the roller 12. In some examples, installing the shim 36 at the roller's first end 40 serves to correct the problem of the curtain's lower end 30 tending to migrate laterally toward the second end 42 as the lower end 30 rises. Likewise, installing the shim 36 at the roller's second end 42 serves to correct the problem of the curtain's lower end 30 tending to migrate laterally toward the first end 40 as the lower end 30 rises.

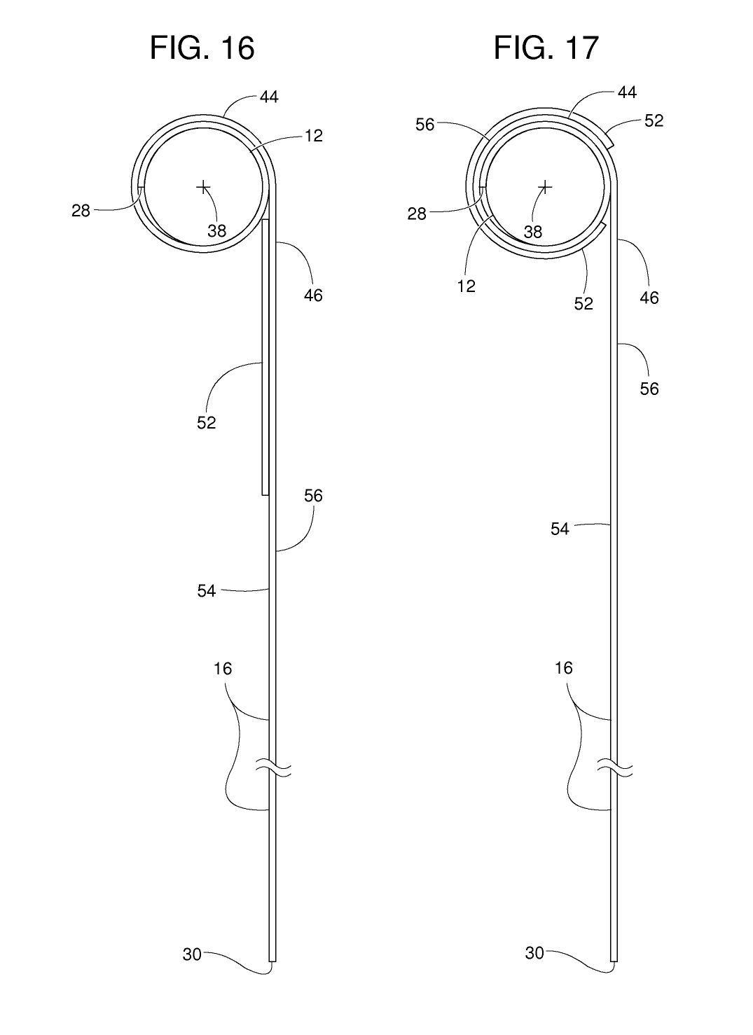

Although FIG. 12 shows the shim 36 wrapped around and fastened to the roller 12, FIGS. 16 and 17 show alternate shim locations. In the illustrated example of FIG. 16, a shim 52 (e.g., similar to the shim 36) is attached to a front side 54 of the curtain 16. In such examples, as the door opens and the curtain's lower end 30 rises, the shim 52 and the curtain 16 wrap around the roller 12 to effectively increase the roller's circumference in the area of the shim 52. In this example, the shim 52 is curved more when the curtain 16 is in the open position than when the curtain 16 is in the closed position. In some examples the shim 52 extends the full vertical length of the curtain 16. In some examples, the shim 52 extends only part way along the length of the curtain 16. In some such examples, the shim 52 is biased toward the curtain's upper end 28 to reduce the problem of curtain wrinkling near its open position, wherein such wrinkling can be caused by excessive or uneven curtain thickness. In other examples, the shim 52 may be located more towards the lower end 30 of the curtain 16 such that the effective circumference of the roller 12 does not begin to increase until the door 10 is partially open. In some examples, there may be multiple shims 52 located along different portions of the length of the curtain 16.

In FIG. 17, the shim 52 is attached to a back side 56 of the curtain 16. As the door opens, the curtain 16 wraps over the shim 56, thereby providing similar functionality to the shim arrangement shown in FIG. 16. In FIG. 16, however, the shim 52 might be less visible even when the door is closed.

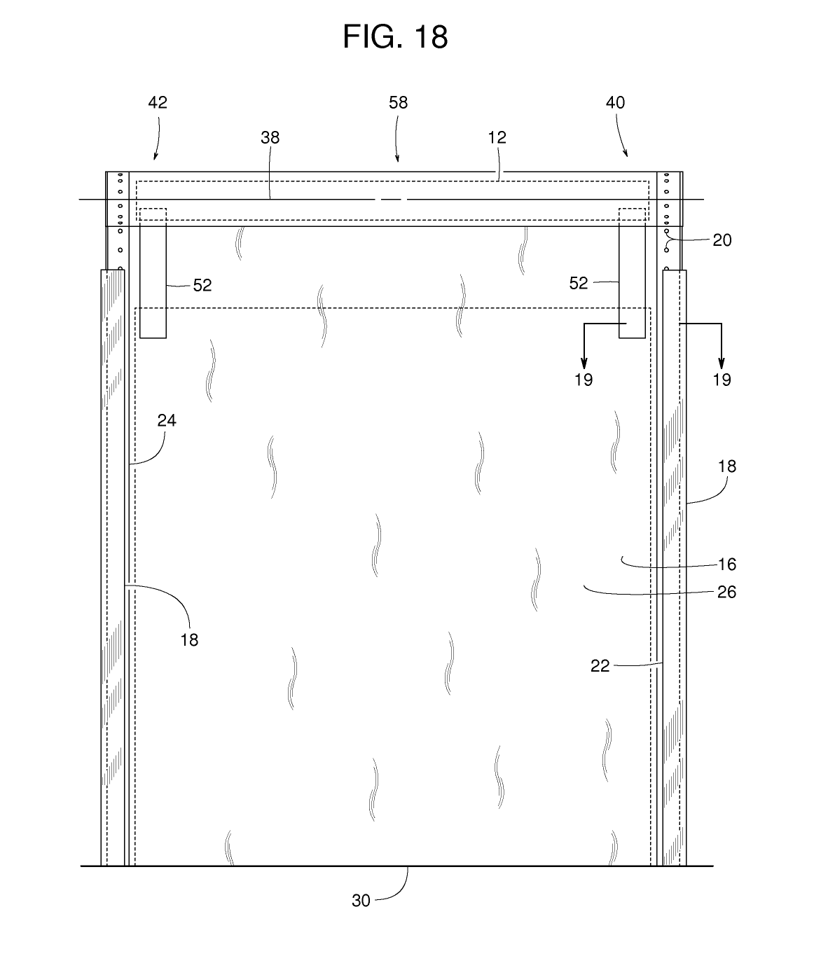

In some examples, as shown in FIGS. 18 and 19, there can be a need to add a shim to both ends of the roller 12 and/or at a central location 58 along the roller's length. In the example illustrated in FIGS. 18 and 19, for instance, the curtain 16 may have a point of greatest thickness (e.g., a maximum edge thickness 60) on the edge sections 22, 24 that is significantly greater than the average material thickness 32 of the curtain's main section 26 (e.g., due to the buttons 20, the raised portion 34, etc. on the edge sections 22, 24). Consequently, as the door opens and the curtain 16 wraps progressively around the roller 12, the edge sections 22, 24 tend to stack or buildup to a greater radial distance than the curtain's main section 26. This can cause the main section 26 to collapse radially inward against the outer diameter of the roller 12 and pull the edge sections 22, 24 toward each other.

To reduce this problem, the shims 52 having a thickness 62 approximately equal to the point of greatest thickness of the curtain 16 (e.g., the maximum edge thickness 60) are attached to the curtain 16 at the positions shown in FIGS. 16, 18 and 19. FIG. 17 shows an alternate shim position. Although the lateral placement of the shim is shown near the ends 40, 42 of the roller 12, the shims 52 may be placed at other locations closer to the central location 58. In the illustrated example, as the curtain 16 starts opening, the curtain 16 carries the relatively thick shims 52 up and around the roller 12 such that the thickness of shims 52 spans the radial gap between the first overlapping layers of the curtain's main section 26. In some examples, the main section 26 is adequately supported when the shims 52 have a shim thickness 62 of a magnitude that is closer to the point of greatest thickness of the curtain 16 (e.g., the maximum edge thickness 60) than to the average material thickness 32 of the curtain 16. In some examples, the material thickness 32 is about 0.026 inches (e.g., between 0.015 inches and 0.25 inches), maximum edge thickness 60 is about 0.750 inches (e.g., between 0.5 inches and 1.25 inches), and shim thickness is about 0.750 to 1 inch. In some examples, the shim 52 is a compressible, closed-cell polyethylene foam pad, which provides a good combination of curtain support, flexibility and durability. In some examples, the shims 52 are spaced apart from the edge sections 22, 24 so that the shims 52 do not add to the edge sections' maximum thickness 60. In some examples, the shims 52 are vertically elongate when the curtain 16 is closed so that the shims 52 are sufficiently long to wrap about 360 degrees around the roller 12 when the curtain 16 opens.

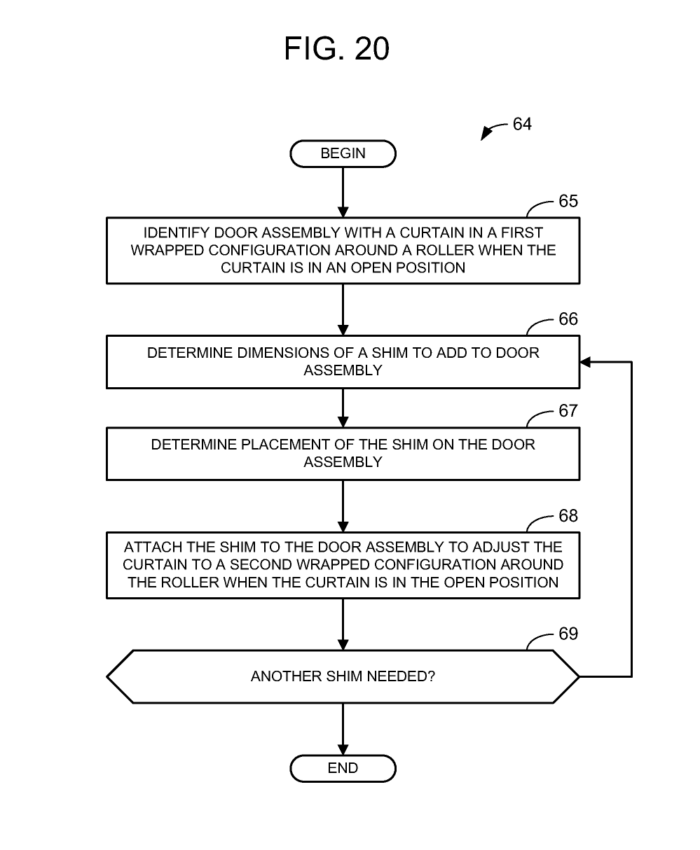

FIG. 20 illustrates an example door method 64 using one or more of the example doors disclosed herein. The example of FIG. 20 begins at block 65 by identifying a door assembly with a curtain 16 in a first wrapped configuration around a roller 12 when the curtain 16 is in the open position. In some examples, the first wrapped configuration corresponds to the curtain 16 being misaligned when wrapped around the roller 12. At block 66, dimensions for a shim 36, 52 to be added to the door assembly are determined. In some examples, the dimensions of the shim 36, 52 are determined based on the extent of the misalignment of the curtain 16. For example, greater misalignment may necessitate a longer and/or thicker shim In some examples, the thickness of the shim is determined relative to the point of greatest thickness of the curtain 16. In some examples, the width of the shim is determined based on the width of the curtain 16 and/or the roller 12.

At block 67, a placement of the shim 36, 52 on the door assembly is determined. In some examples, the placement of the shim 36, 52 depends upon the nature of the misalignment of the curtain 16. For example, if the curtain 16 is misaligned such that the edge of the curtain migrates (e.g., becomes laterally offset) in the direction of the second end 42 as it wraps around the roller 12 (e.g., as shown in FIG. 6), the placement of the shim 36, 52, 52 may be near the first end 40. If the misalignment of the curtain 16 is caused by a collapse of the main section 26 when wound around the roller, the placement of the shim 36, 52 may be closer to the central location 58 of the curtain 16. In addition to the lateral placement of the shim 36, 52, in some examples, the placement of the shim 36, 52 as between being on the roller 12, on the front side 54 of the curtain 16, or on the back side 56 of the curtain 16 is determined. Further, in examples where the shim 36, 52 is attached to the curtain 16, the placement of the shim 36, 52 relative to the upper and lower ends 28, 30 of the curtain 16 is determined.

At block 68, the shim 36, 52 is attached to the door assembly to adjust the curtain 16 to a second wrapped configuration around the roller 12 when the curtain 16 is in the open position. In some examples, the second wrapped configuration corresponds to the curtain 16 being in alignment when wrapped around the roller 12. In other words, in some examples, the lower end 30 of the curtain 16 in the first wrapped configuration is laterally offset relative to the lower end 30 of the curtain 16 in the second wrapped configuration. At block 69, whether another shim is needed is determined. If so, the example method returns to block 65. Otherwise, the example method of FIG. 20 ends.

While an example method is describe in connection with FIG. 20, one or more of the elements, processes and/or devices illustrated in FIG. 4 may be combined, divided, re-arranged, omitted, eliminated and/or implemented in any other way. For instance, in some examples, the dimensions of the shim 36, 52 (determined at block 66) may impact the determination of the placement of the shim 36, 52 (determined at block 67). Likewise, in some examples, the placement of the shim 36, 52 (determined at block 67) may impact the determination of the dimensions of the shim 36, 52 (determined at block 66). Thus, blocks 66 and 67 may be reversed and/or implemented in combination.

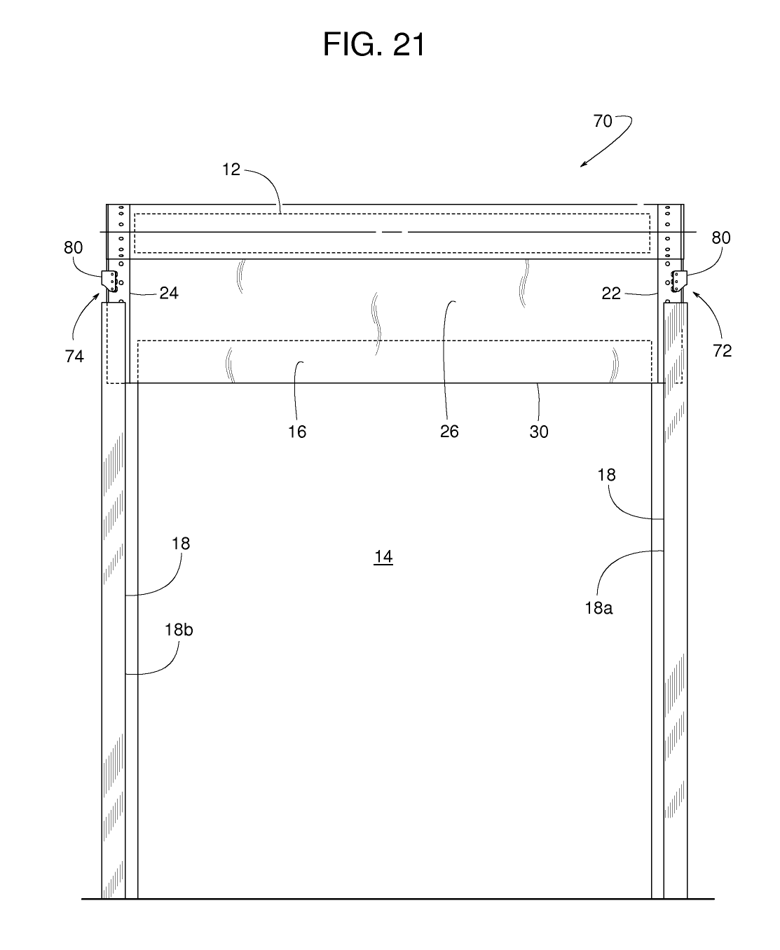

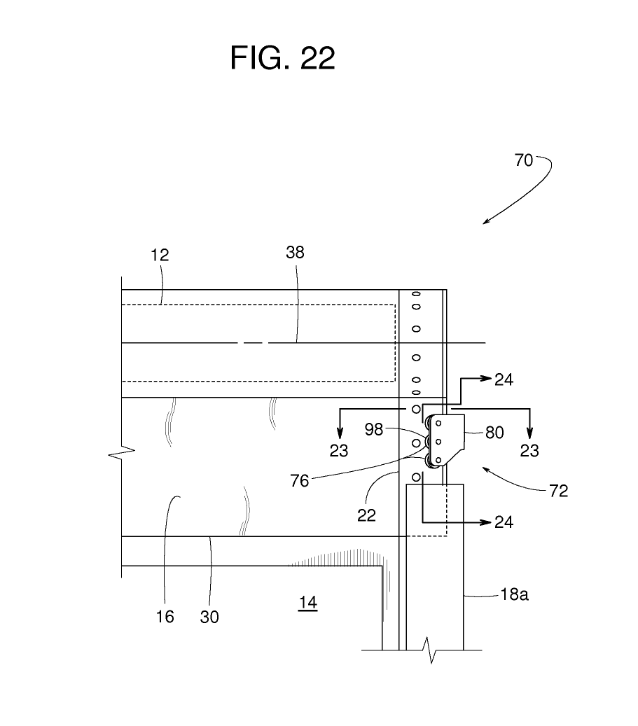

In addition or alternatively, some example doors disclosed herein include curtain guide members that help guide the curtain 16 onto the roller 12 and/or to help guide a dislodged curtain 16 back into the tracks 18. In some examples, such guide members are used in a door system in conjunction with the example shims 36, 52 described above because misaligned curtains 16 may be more likely to become dislodged. In other examples, such guide members are used in place of the example shims 36, 52 to hold the curtain in alignment with tracks 18 (e.g., maintain the curtain substantially centered between the tracks) as it is wrapped or unwrapped about the roller 12. FIGS. 21-24, for instances, shows an example door 70 with the curtain 16 having the edge sections 22, 24 that extend into and are guided by a first pair of guide members 72 and a second pair of guide members 74. Each pair of the guide members 72, 74 are spaced apart from and above their respective tracks 18a, 18b but below the roller 12 to provide room for refeeding the curtain's edge sections 22, 24 back into tracks 18 when necessary.

In the illustrated example, the first pair of guide members 72 comprises a first front guide member 76 and a first back guide member 78 that are attached to a bracket 80. The curtain's first edge section 22 extends into a first gap 82 between the first guide members 76, 78, wherein the first guide members 76, 78 retain and/or guide the raised portion 34 (e.g., a keder edge) on the curtain's first edge section 22. Likewise, the second pair of guide members 74 is constructed similar to the first pair of guide members 72, wherein the second pair of guide members 74 includes a second front guide member and a second back guide member similar to the guide members 76, 78.

In some examples, the guide members 76, 78 are formed of a material that is softer than the tracks 18. In some examples, the guide members 76, 78 are rollers for reducing friction. In some examples, the guide members 76, 78 each comprise a plurality of rollers 98 to reduce wear by broadly distributing the points of contact between the curtain's first edge section 22 and the guide members 76, 78. For instance, in some examples, the first front guide member 76 comprises a first front series of guide rollers 84, and the first back guide member 78 comprises a first back series of guide rollers 86. Likewise, in some examples, the second pair of guide members 74 has a similar arrangement of rollers.

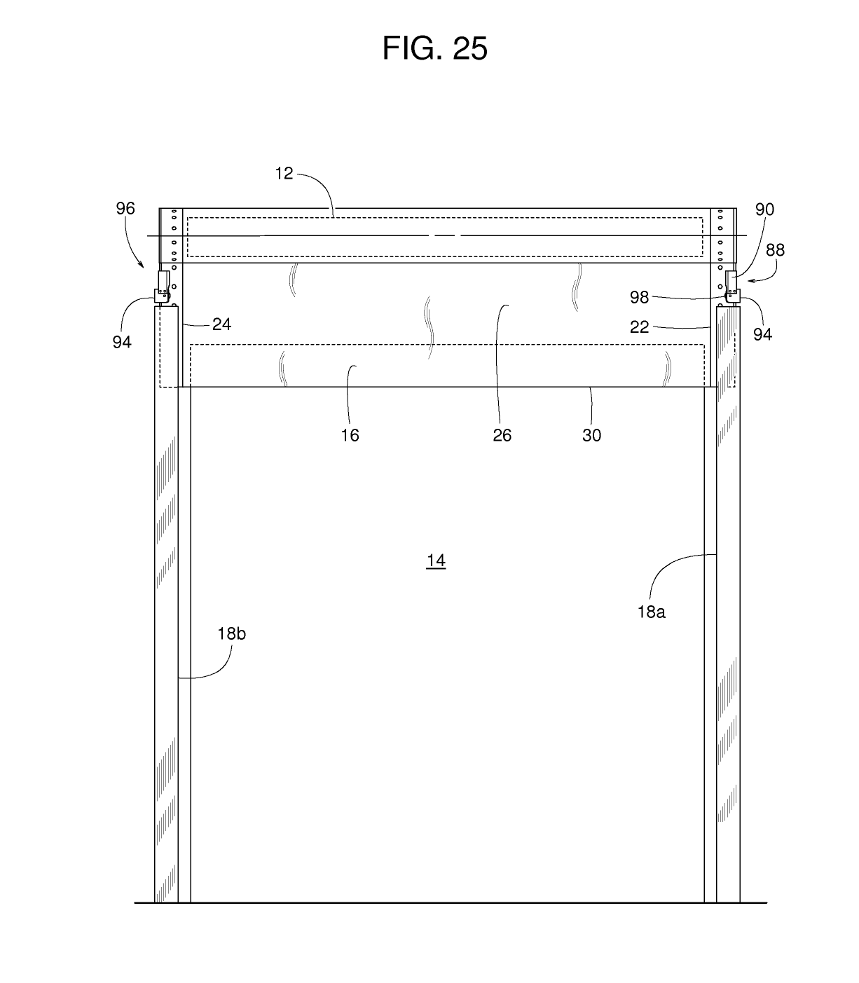

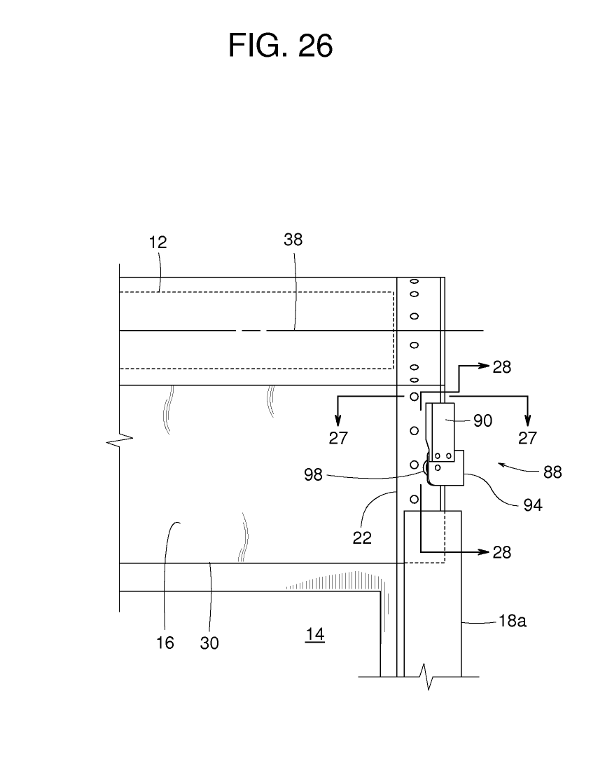

In addition or alternatively, some example curtain guide members comprise one or more stationary guide blocks, with or without supplemental rollers. FIGS. 25-28, for instance, show a first pair of guide members 88 comprising a first front guide member 90 and a first back guide member 92 attached to a bracket 94. Some examples of the guide members 90, 92 are stationary blocks of a low friction polymeric material (e.g., UHMW). In the illustrated example, the guide members 90, 92 are separate pieces; however, in other examples, the guide members 90, 92 are made as a unitary piece. FIGS. 25-28 also show a second pair of guide members 96 similar to the first pair of guide members 88, wherein the second pair of guide members 96 includes a second front guide member and a second back guide member similar to the first front and back guide members 90, 92.

In some examples, such as the one illustrated in FIGS. 25-28, the guide members 90, 92 also include one or more rollers 98 attached to the bracket 94. The rollers 98 enhance the guide members' ability in guiding the curtain 16 onto the roller 12 and/or enhance the guide members' ability in guiding a dislodged curtain 16 back into the tracks 18.

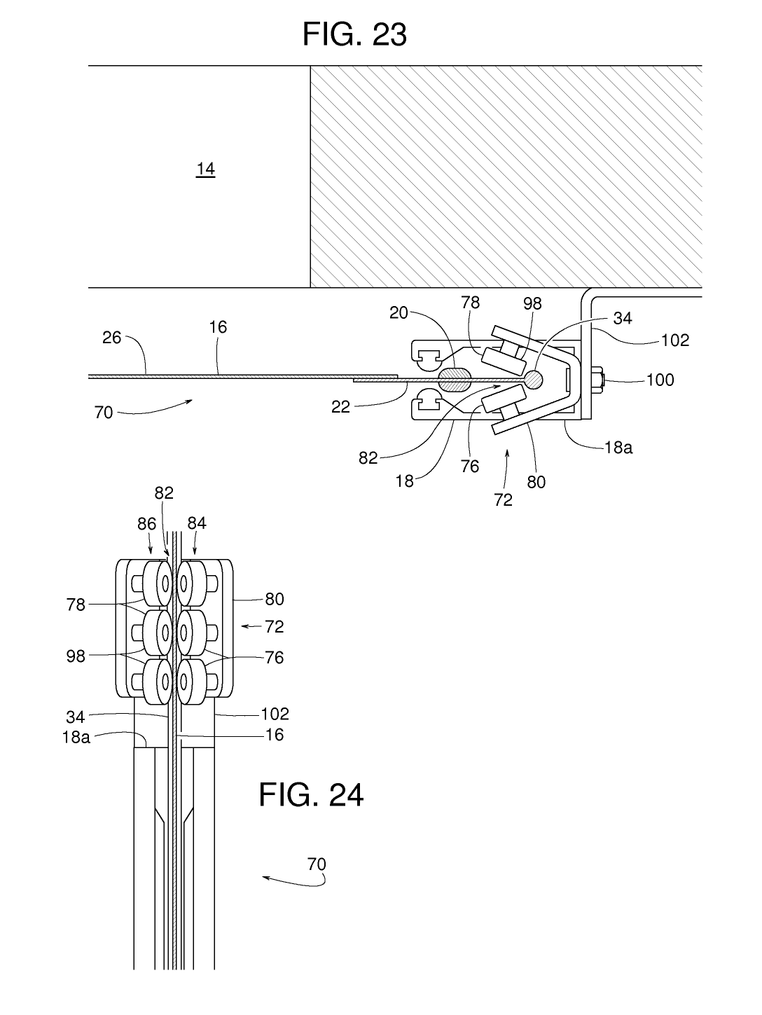

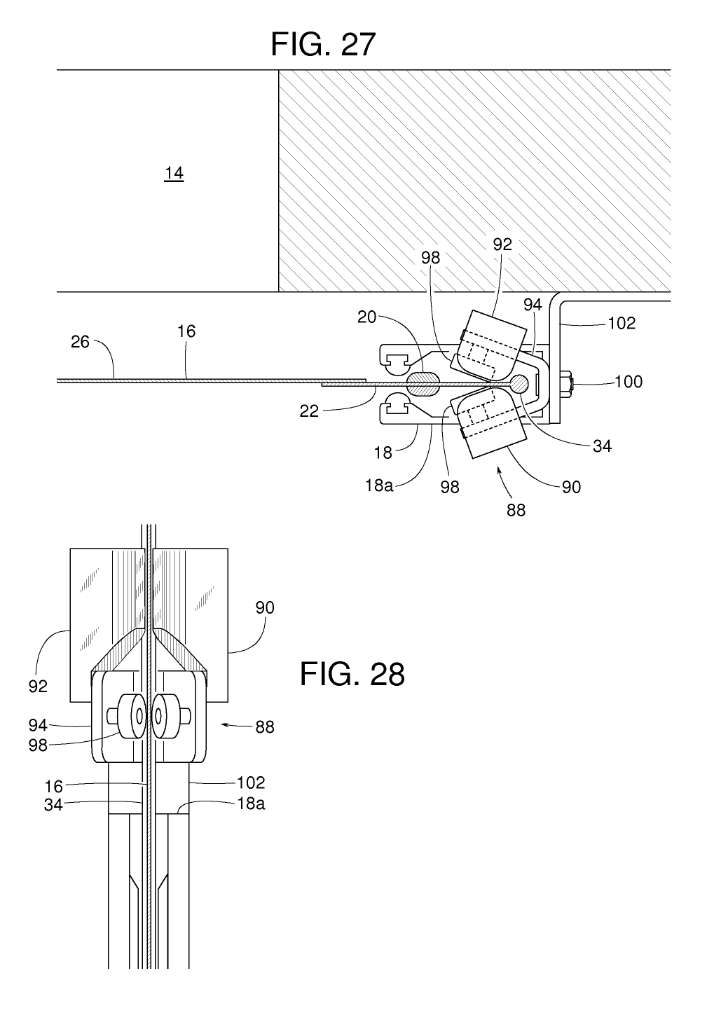

The brackets 80, 94, in the illustrated example, may be mounted and supported by any suitable means. In some examples, a fastener 100 (FIGS. 23 and 27) connects the brackets 80, 94 to a stationary structural member 102 (e.g., a bracket, a frame, a structural angle, etc.).

Although certain example methods, apparatus and articles of manufacture have been described herein, the scope of the coverage of this patent is not limited thereto. On the contrary, this patent covers all methods, apparatus and articles of manufacture fairly falling within the scope of the appended claims either literally or under the doctrine of equivalents.

1. A door for selectively blocking and unblocking a doorway, the door comprising:
a roller to be proximate an upper end of the doorway, the roller to be horizontally elongate between a first end of the roller and a second end of the roller, the roller to be rotatable about an axis; and
a curtain having a wrapped section wrapped around the roller and an unwrapped section extending tangentially away from the wrapped section, the unwrapped section adjoining the wrapped section at a first point proximate the first end of the roller, the unwrapped section adjoining the wrapped section at a second point proximate the second end of the roller, the curtain to be movable selectively to a closed position to block the doorway, an open position to unblock the doorway and an intermediate position between the closed position and the open position, the first point and the second point being closer to the axis when the curtain is in the closed position than when the curtain is in the open position; and
a shim attached to at least one of the curtain or the roller such that the axis is closer to the second point than to the first point when the curtain is at the intermediate position.

2. The door of claim 1, wherein the axis is to be closer to the second point than to the first point when the curtain is at the open position.

3. The door of claim 1, wherein the roller has an effective circumference that is greater at the first end than at the second end.

4. The door of claim 1, wherein the roller has a first effective circumference at the first end and a second effective circumference at the second end, a difference in first and second effective circumferences being adjustable.

5. The door of claim 1, wherein the shim is proximate the first end of the roller when the curtain is in the open position.

6. The door of claim 1, wherein the shim is attached to the curtain.

7. The door of claim 1, wherein the shim is attached to the roller.

8. The door of claim 1, wherein the shim is curved more when the curtain is in the open position than when the curtain is in the closed position.

9. A door for selectively blocking and unblocking a doorway, wherein the doorway includes an upper end, a lower end, a first lateral edge and a second lateral edge, the door comprising:
a roller to be proximate the upper end of the doorway, the roller to be horizontally elongate between a first end of the roller and a second end of the roller, the roller to be rotatable about an axis;
a first track to be vertically elongate and proximate the first lateral edge;
a second track to be vertically elongate and proximate the second lateral edge;
a curtain to be attached to and wrapped around the roller, the curtain comprising a main section, a first edge section and a second edge section, the first edge section extending into the first track, the second edge section extending into the second track, and the main section extending between the first edge section and the second edge section, the curtain having an average material thickness in the main section and a point of greatest thickness in the first and second edge sections, the curtain to be movable selectively to a closed position to block the doorway and an open position to unblock the doorway;
a first shim to overlie the main section of the curtain, the first shim to be closer to the roller than to the lower end of the doorway when the curtain is in the closed position, the first shim to be closer to the first track than to the second track; and
a second shim to be spaced apart from the first shim and to overlie the main section of the curtain, the second shim to be closer to the second track than to the first track, the second shim to be closer to the roller than to the lower end of the doorway when the curtain is in the closed position, each of the first shim and the second shim having a shim thickness that is greater than the average material thickness, the shim thickness being of a magnitude that is closer to the point of greatest thickness than to the average material thickness.

10. The door of claim 9, wherein the first shim is to be spaced apart from the first edge section, and the second shim is to be spaced apart from the second edge section.

11. The door of claim 9, wherein each of the first shim and the second shim is to be vertically elongate when the curtain is in the closed position.

12. The door of claim 9, wherein each of the first shim and the second shim is to be curved more when the curtain is in the open position than when the curtain is in the closed position.

13. The door of claim 9, wherein each of the first shim and the second shim is to be attached to the main section of the curtain.

14. The door of claim 9, wherein each of the first shim and the second shim comprises a foam pad.

15. The door of claim 9, wherein the first and second ends of the roller are to engage the curtain, and the first and second edge sections of the curtain are to overhang horizontally beyond the first and second ends of the roller when the curtain is in the open position.

16. A door method that involves selectively installing a shim for adjusting an alignment of a lower end of a curtain in a lateral direction relative to a roller of a door, wherein the roller is horizontally elongate in the lateral direction and the curtain is movable selectively to a closed position for blocking a doorway and an open position for unblocking the doorway, the door method comprising:
fastening an upper end of the curtain to the roller such that the curtain is in a first wrapped configuration around the roller when the curtain is in the open position; and
attaching the shim to at least one of the roller or the curtain such that the curtain is in a second wrapped configuration around the roller when the curtain is in the open position, the lower end of the curtain in the first wrapped configuration being laterally offset to the lower end of the curtain in the second wrapped configuration.

17. The door method of claim 16, wherein the roller is horizontally elongate between a first end of the roller and a second end of the roller, and the shim is closer to the first end of the roller than to the second end of the roller when the curtain is in the open position while the shim is attached to at least one of the roller or the curtain.

18. The door method of claim 16, wherein the shim is closer to the upper end of the curtain than to the lower end of the curtain when the shim is attached to at least one of the roller or the curtain.

19. The door method of claim 16, wherein the shim is attached to the curtain upon attaching the shim to at least one of the roller or the curtain.

20. The door method of claim 16, wherein the shim is curved more when the curtain is in the open position than when the curtain is in the closed position.

21-27. (canceled)
